(19) United States
(12) Patent Application Publication
(10) Pub. No.: US 2022/0304279 A1
(43) Pub. Date: Sep. 29, 2022

(54) PET TOY

(71) Applicant: Doskocil Manufacturing Company, Inc., Arlington, TX (US)

(72) Inventors: Jill JACKSON, Fort Worth, TX (US); Ronald BAGLEY, Dallas, TX (US); Sunil PINTO, Arlington, TX (US); Josiah WILHELM, Fort Worth, TX (US)

(21) Appl. No.: 17/516,905

(22) Filed: Nov. 2, 2021

Related U.S. Application Data
(60) Provisional application No. 63/164,710, filed on Mar. 23, 2021.

(51) Int. Cl. A01K 15/02

(52) U.S. Cl. CPC A01K 15/026

(57) ABSTRACT

A pet toy includes a resilient base member having a concave surface, and a holding member having a first end and a second end, the first and second ends attached to the resilient base member at the concave surface to form a passage between the holding member and the concave surface, the passage configured and arrange to frictionally hold food stuff therein.

### CROSS-REFERENCE TO RELATED APPLICATIONS

This application claims priority to U.S. Provisional Patent Application No. 63/164,710, filed on Mar. 23, 2021. The entire disclosure of which is incorporated herein by reference.

### FIELD OF THE INVENTION

The present invention relates to a pet toy. In particular, the present invention relates to a pet toy having an adjustable holding member to hold treats or food stuff.

### BACKGROUND OF THE INVENTION

Conventional pet toys exist that can be used in conjunction with treats. Many of these conventional toys are hollow structures in which a paste or other treats can be inserted. Some conventional toys incorporate dog treats with puzzles to increase a dog's interest.

### SUMMARY

It has been discovered that conventional animal toys are not desirous for some animals. In particular, it has been found that some animals eat fast, which results in the animal failing to properly chew their food. Additionally, eating fast can result in health problems, such as obesity, Gastric Dilatation-Volvulus (GDV), and poor digestion.

Obesity is a common problem among some animals. For example, 54% of dogs are classified as obese, based on a 2017 report from the Association for Pet Obesity Prevention. GDV is caused when the stomach of a dog is overstretched and is rotated by excessive gas content. GDV can cause shock and result in death. Poor digestion can cause choking, gagging, vomiting, diarrhea, excess gas and other issues.

Additionally, in some animals fast eating can cause aggressive behavior. If this aggressive behavior is unchecked or not controlled, the animal may develop serious aggression issues and strike out to other pets or owners.

It has been found that many of the conventional toys are not desired, since the treats are removed too quickly from the treat and pets can get bored quickley.

Thus, it has been found that an improved pet toy is desired. In view of the state of the known technology, a first aspect of the present disclosure is to provide a pet toy that includes a resilient base member having a concave surface, and a holding member having a first end and a second end, the first and second ends attach to the resilient base member at the concave surface to form a passage between the holding member and the concave surface, the passage is configured and arrange to frictionally hold food stuff therein.

In a second aspect of the pet toy in accordance with the first aspect, the concave surface includes teething nubs.

In a third aspect of the pet toy in accordance with the previous aspects, the resilient base member includes a hollow interior portion.

In a fourth aspect of the pet toy in accordance with the previous aspects, the concave surface includes an opening which provides access to the hollow interior portion.

In a fifth aspect of the pet toy in accordance with the previous aspects, the holding member is a rope lace.

In a sixth aspect of the pet toy in accordance with the previous aspects, the holding member is a first holding member and the pet toy further includes a second holding member positioned adjacent the first holding member.

In a seventh aspect of the pet toy in accordance with the previous aspects, the concave surface is a first concave surface and the pet toy further includes a second concave surface.

In an eighth aspect of the pet toy in accordance with the previous aspects, the second concave surface has a radius of curvature that is less than a radius of curvature of the first concave surface.

In a ninth aspect of the pet toy in accordance with the previous aspects, the holding member is a first holding member and the pet toy further includes a second holding member passing through the second concave surface.

In a tenth aspect of the pet toy in accordance with the previous aspects, the passage is a first passage and the second holding member and the second concave surface for a second passage, the second passage having a smaller cross sectional area than the first passage.

In an eleventh aspect of the pet toy in accordance with the previous aspects, the first concave surface includes a first opening which provides access to a hollow interior portion of the resilient member and the second concave surface has a second opening which provides access to a hollow interior portion of the resilient member, the second opening having a diameter that is less than the diameter of the first opening.

In a twelfth aspect of the pet toy in accordance with the previous aspects, the second concave surface includes teething nubs.

In a thirteenth aspect of the pet toy in accordance with the previous aspects, the first holding member is configured to be adjusted when a force is applied to the second holding member.

In a fourteenth aspect of the pet toy in accordance with the previous aspects, the holding member is adjustable.

Embodiments of the present invention are improved pet toys that prevent pets from removing treats too quickly and increase play time. Thus, embodiments of the present invention may reduce health problems, such as obesity, Gastric Dilatation-Volvulus (GDV), and poor digestion. Additionally, embodiments of the present invention may reduce aggression issues.

### BRIEF DESCRIPTION OF THE DRAWINGS

The invention will be explained in more detail hereinafter with reference to the drawings.

FIG. 1 is a front top perspective view of a pet toy according to an embodiment of the present invention;

FIG. 2 is a bottom rear perspective view of the pet toy of FIG. 1;

FIG. 3 is an elevational side view of the pet toy of FIG. 1;

FIG. 4 is a front view of the pet toy of FIG. 1;

FIG. 5 is a rear view of the pet toy of FIG. 1;

FIG. 6 is a top view of the pet toy of FIG. 1;

FIG. 7 is a bottom view of the pet toy of FIG. 1;

FIG. 8 is a cross sectional view of the pet toy taken along lines 8-8 of FIG. 6;

FIG. 9 is a cross sectional view of the pet toy of FIG. 8 with the holding member tightened to hold a treat;

FIG. 10 is a perspective view of the cross sectional view of the pet toy holding a treat; and

FIG. 11 is side view of the pet toy of FIG. 10.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

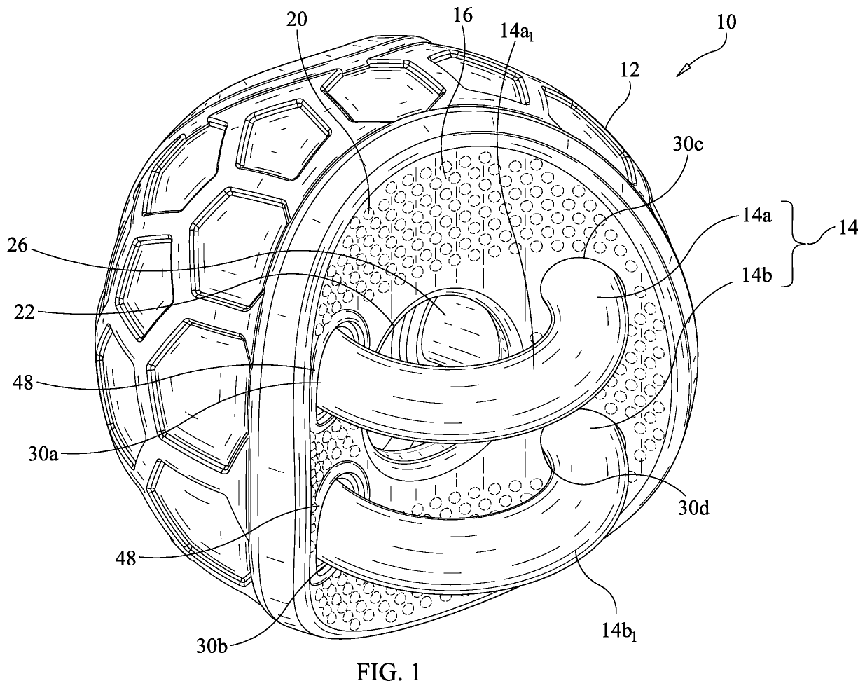

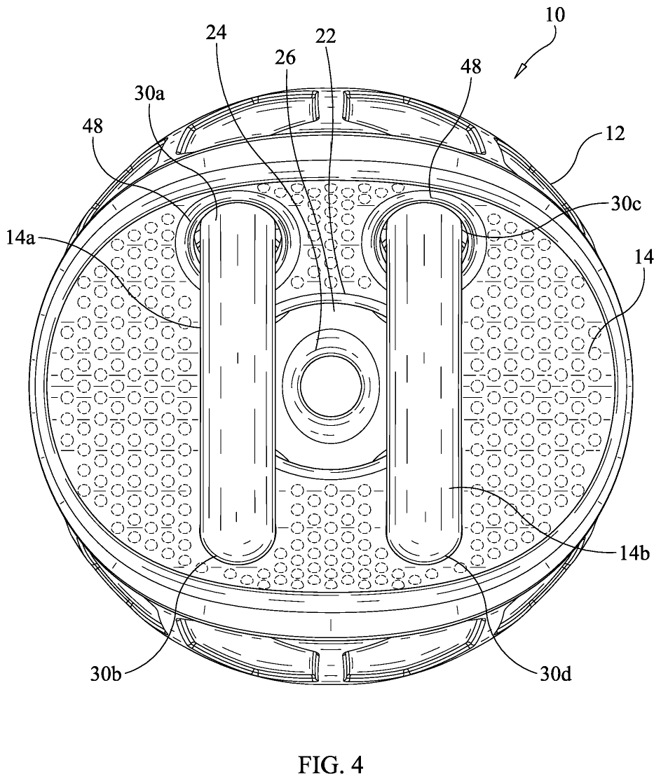

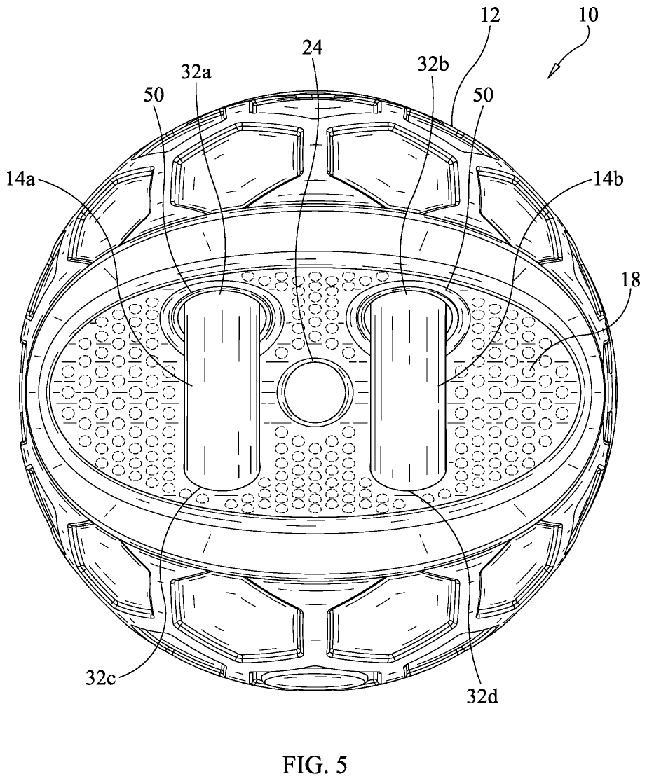

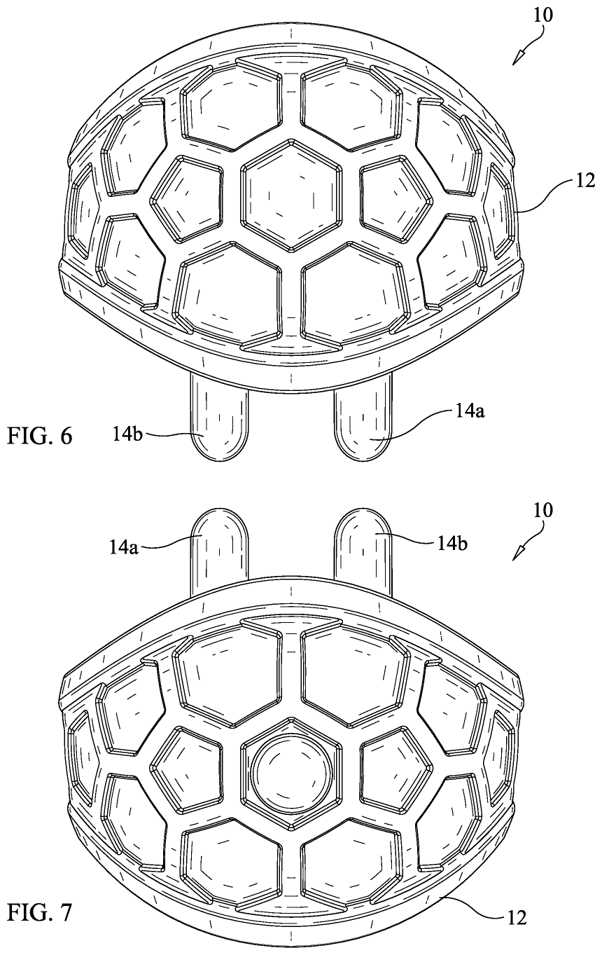

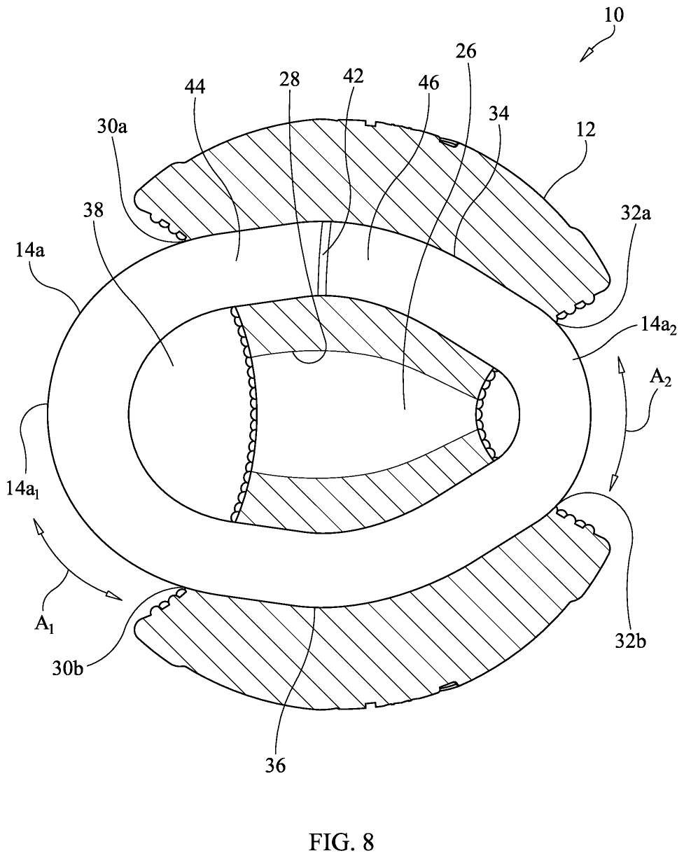

Referring initially to FIGS. 1-7, a pet toy 10 is illustrated in accordance with an embodiment. The pet toy 10 includes a resilient base member 12 and a plurality of holding members 14 (rope laces).

The resilient base member 12 is preferably rubber or any suitable thermo plastic or plastic, or can be any suitable durable material. As can be understood, the pet toy 10 will likely be subject to chewing by an animal and thus the material should be somewhat resilient to prevent destruction of the toy 10 due to prolonged chewing by an animal, such as a dog.

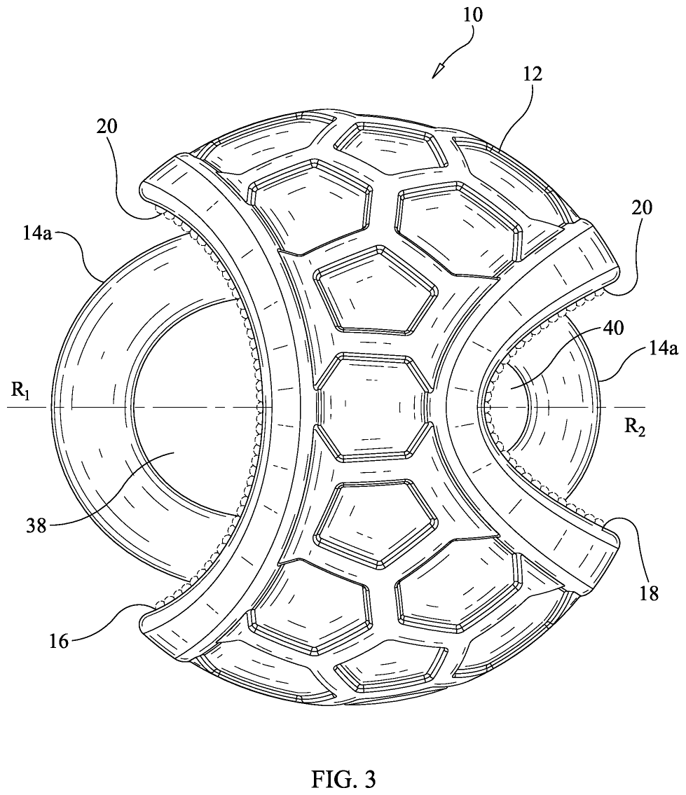

The resilient base member 12 is in the general shape of a ball and has a first concave surface 16 (large arcuate cutout) and a second concave surface 18 (small arcuate cutout). The first concave surface 16 has a first radius of curvature R₁ and the second concave surface 18 has a second radius of curvature R₂. The second radius of curvature R₂ is preferably less than the first radius of curvature R₁. Thus, as can been seen in FIGS. 3-5, for example, the second concave surface 18 extends along a conferential area of the toy 10 that is less than the circumneutral area of the first concave surface 16. However, it is noted that the first and second radius of curvatures R₁, R₂ can be the same or substantially the same. Moreover, as can be seen in FIG. 3, the radius of curvatures R₁, R₂ and the concaves surfaces 16 and/or 18 can vary, such that the concaves surfaces 16 and/or 18 have a parabolic shape.

Each of the first and second concave surfaces 16 and 18 can have teething nubs 20 thereon and an opening or hole therein. In particular, the first concave surface has a first opening 22 and the second concave surface 18 has a second opening 24. The holes or openings 22 and 24 in the concave surfaces 16 and 18 enable access to a hollow interior portion 26 of the base member 12 and can form a through passage 28 therein. The opening 22 in the first concave surface 16 can be larger than the opening 24 in the second concave surface 18. However, it is noted that the openings 22 and 24 can be any size and positioned in any manner on the surfaces. Moreover, in one embodiment there can be only one opening disposed on either surface, or in another embodiment there can be no openings in the concave surfaces.

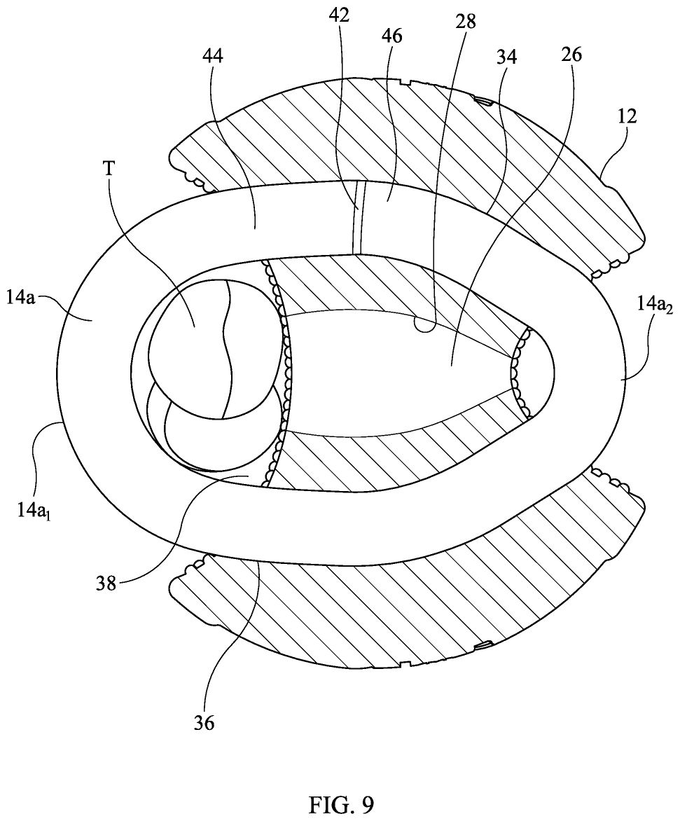

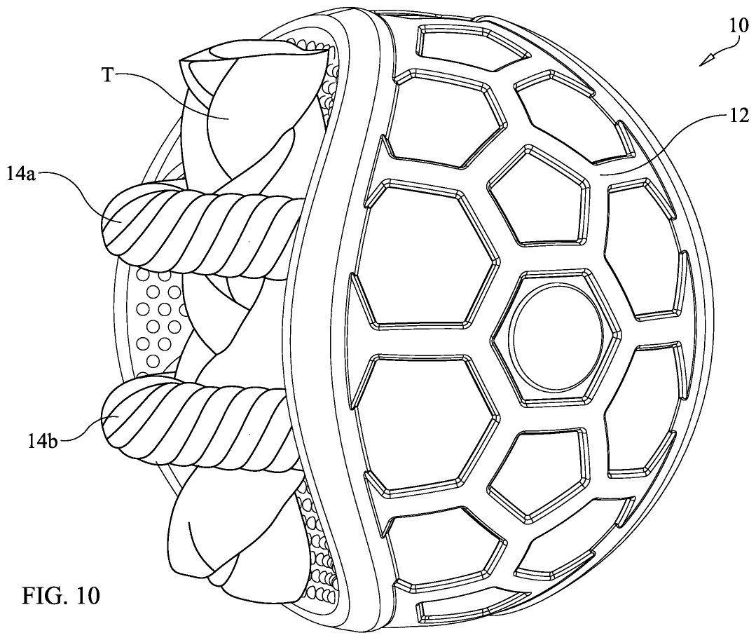

The openings 22 and 24 enable access to the hollow interior portion 26 of the toy 10, as shown in FIGS. 8 and 9. The hollow interior portion 26 of the toy 10 can be used to hold kibble or any other edible or inedible substance that a pet may enjoy. It is noted that in one embodiment, the toy 10 does not have a hollow interior portion and can be completely or partially solid.

The concave surfaces 16 and 18 can include holding members 14. As illustrated in one embodiment, two holding members 14 pass through each of the concave surfaces 16 and 18. As can be understood, in one embodiment the pet toy 10 includes a first holding member 14a and a second holding member 14b. The first and second holding members 14a and 14b are substantially identical and therefor any description of one holding member 14 can be applicable to the other holder member 14.

The holding members 14 are preferably braided ropes or laces. Each of the holding members 14a and 14b has a first portion (14a₁ and 14b₁) and a second portion (14a₂ and 14b₂). The first portions 14a₁ and 14b₁ of the first and second holding members 14a and 14b pass through openings 30a-30d in the first concave surface 16 of the resilient base member 12 surface. Further, the second portions 14a₂ and 14b₂ of the first and second holding members 14a and 14b pass through openings 32a-32d in the second concave surface 18, such that the holding members 14a and 14b form passages through the base member 12 from the first concave surface 16 to the second concave surface 18.

As shown in FIGS. 8 and 9, the first portion 14a₁ of the first holding member 14a passes through the openings 30a and 32a in the first concave surface 16 and the second portion 14a₂ of the first holding member 14a passes through the openings 32a and 32b in the second concave surface 18. The first portion 14a₁ and second portion 14a₂ form a continuous loop that passes through the first passage 34 and the second passage 36. Further, at least a portion of the first portion 14a₁ and second portion 14a₂ are disposed within the first passage 34 and the second passage 36. The second holding member 14b passes through the body 12 in a similar manner and any description of the first holding member 14a passing through passages 34 and 36 applies to the passage of the second holding member 14b.

Further, the first portions 14a₁ and 14b₁ of the first and second holding members 14a and 14b pass through openings and form a first passage 38 between the holding members 14a and 14b and the concave surface 16. The passage 38 is configured and arranged to frictionally hold food stuff therein. The holding members 14a and 14b passes though the base member 12 and out of the base member 12 at the second concave surface 18. Thus, as can be understood, the second portions 14a₂ and 14b₂ of the first and second holding members 14a and 14b pass through openings 32a-32d and form a second passage 40 between the holding members 14a and 14b and the concave surface 18. The second passage 40 is configured and arranged to frictionally hold food stuff therein.

As can be understood, and shown in FIGS. 8 and 9, the holding members 14a and 14b can each be a continuous member that passes through the base member 12 forming a first arcuate portions (first portions 14a₁ and 14b₁) at the first concave surface 16 and a second arcuate portion (second portion 14a₂ and 14b₂) at the second concave surface 18. Thus, in one embodiment, as shown in FIGS. 8 and 9, the holding members 14a and 14b can form a continuous loop that is connected together at a connection part 42. In other words, when forming the holding members 14, the holding members 14 can be a piece of linear rope with a first end 44 and a second end 46. The ends 44 and 46 are connected together within the passage 34 and connected together to form the connection part 42. The connection part 42 can be formed in any stumble manner that would enable to holding member 14 to be securely connected at the first and second ends.

The holding members 14 are fixed to the base member 12 in such a manner that they are capable of moving or sliding relative to the concave surfaces. In other words, as shown in FIGS. 8 and 9, the second portion 14a₂ can be pulled such that the first arcuate portion 14a₁ is adjusted so that the first passage 38 is smaller than when the holding member 14a is in its original position. This adjustability enables treats T (e.g., foodstuff) to be positioned within the passages and then the holding member 14 can be adjusted to snugly hold the treat therein.

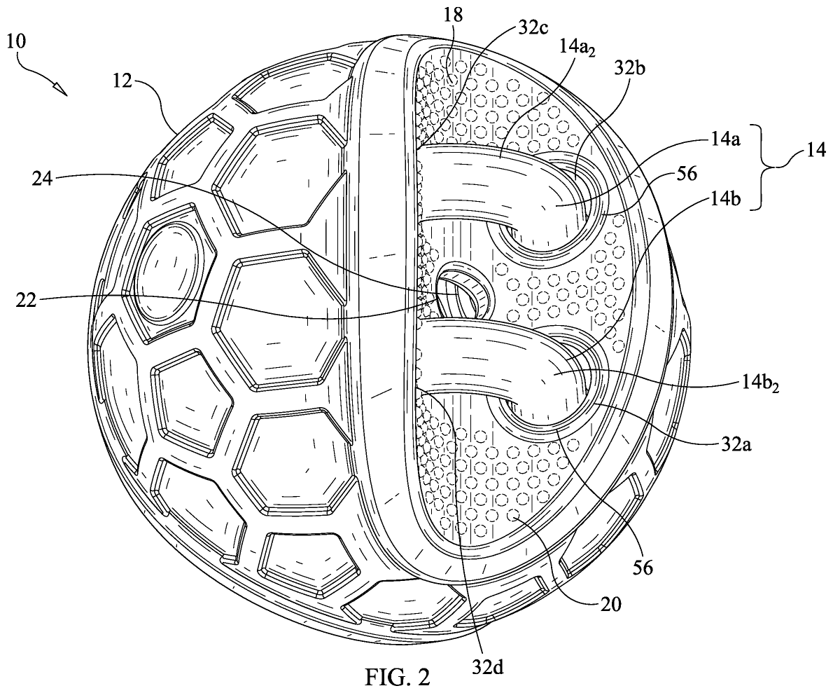

In one embodiment, as seen in FIGS. 1 and 2, the first concave surface 16 has first surface ring details 48 and the second concave surface 18 has surface rings details 50. The surface ring details 48 and 50 indicate to the user from which side to adjust the holding members 14a and 14b. The holding members 14a and 14b in the passage 34 opposite the surface ring details 48 and 50 is the passage in which the connection part 42 is disposed. By indicating from which side to adjust the holding members 14a and 14b, the connection part 42 can be prevented from being pulled out of the passage 34 and exposed to the user.

The second holding member 14b is preferably adjacent and generally parallel to the first holding member 14a. However, it is noted that, if desired only one holding member can be present or more than 2 holding members can be present. Moreover, the holder members 14 do not need to be generally parallel and can be disposed in any manner desired.

As discussed above, the first and second openings 22 and 24 provide access to the hollow interior portion 26 (internal chamber) of the resilient member 12 such that additional treats (e.g., kibble) or foodstuff can be disposed therein.

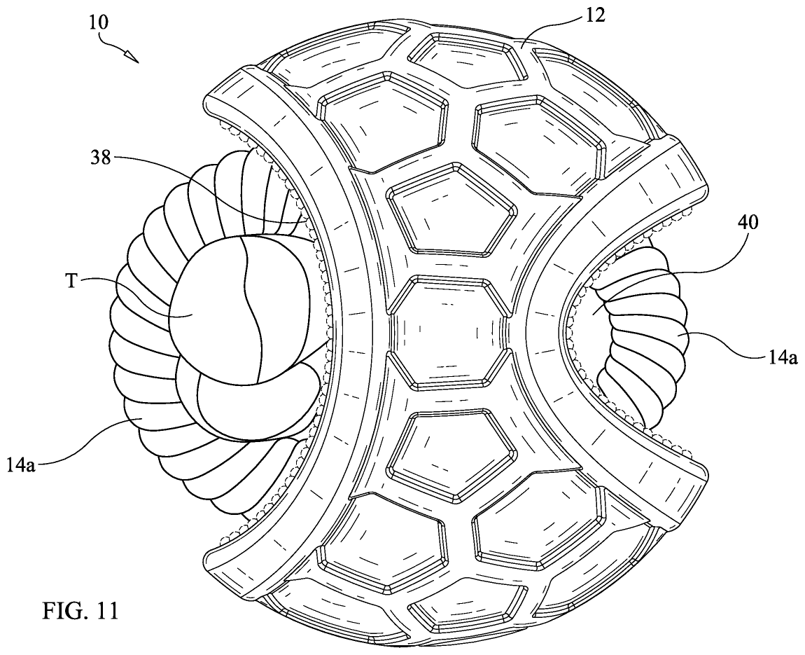

As can be understood, the first concave surface 16 is a cutout that is wide and can be used to hold large treats, see FIGS. 10 and 11. The second concave surface 18 is cutout that is narrow and can be used for holding medium and small treats. Two holding members 14a and 14b are frictional secured via internal rubber channels (e.g., 34 and 36) inside of the toy 10. These holding members 14a and 14b are adjustable and are used to secure the dog treats T into place.

Accordingly, the user can load a treat T into the first and/or second concave surface 16/18 area in the passage 38/40 formed by the holding members 14a and 14b, and secure it by pulling the holding member 14 (i.e., the rope) on the opposite side as indicated by arrows A1 and A2 in FIG. 8. These holding members 14a and 14b act as laces and can be adjusted to fit different sizes of treats T. The pet toy 10 also provides the hollow interior portion 26 that is great for placing loose dog kibble and tiny treats. The larger first opening 22 provides improved pet access to the hollow interior portion 26, although access can be achieved through either opening 22/24.

A user can put treats inside the toy 10 or secure the treats Ton the ball's outside with the holding members 14a and 14b. A pet will have to figure out how to free the treats. Accordingly, the toy 10 can double as a puzzle. The holding members 14a and 14b add a level of difficulty to freeing the treats.

The base member 12 can be a molded member that is formed using any molding process desired. Once the base member 12 has been molded, the holding members 14a and 14b can be inserted into the passages (e.g., 34 and 36) and the ends 44 and 46 of each of the holding members 14 can be coupled or bonded togther to form the connection part 42. The connection part 42 can then be moved to be disposed within the passage 34. If desired, a treat T or other object can be placed within the area between the holding members 14a and 14b and the respetive concave surface.

This toy 10 also has dental benefits. The teething nubs 20 cover the concave surfaces 16 and 18 (i.e., the arcuate cutouts), which help clean teeth through friction as dogs try to free the treats T. Additionally, as described herein the holding members 14a and 14b can be rope that can scrub teeth as dogs try to free the treats.

Moreover, the base member 12 can be covered in a debossed hexagon texture (or any othe suitable texture) that provides the base member 12 with an erratic bounce. These features prevent the treats from easily tumbling out of the toy 10. Animal's will have to use cognitive thinking and trial and error to attempt to retrieve the treats. This will make playtime last longer and prevent dogs from eating too quickly.

Further, embodiments of the present invention can reduce or prevent health problems, such as obesity, gastric dilatation-volvulus (GDV), and poor digestion. Moreover, embodiments of the present invention can reduce aggressive behavior during eating and lead to a more relaxed posture and better eating mannerisms.

### GENERAL INTERPRETATION OF TERMS

In understanding the scope of the present invention, the term “comprising” and its derivatives, as used herein, are intended to be open ended terms that specify the presence of the stated features, elements, components, groups, and/or steps, but do not exclude the presence of other unstated features, elements and components, groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the pet toy.

The terms of degree such as “substantially” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. The functions of one element can be performed by two, and vice versa. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed:

1. A pet toy comprising:
a resilient base member having a concave surface; and
a holding member having a first portion and a second portion, the first and second portions pass through the resilient base member at the concave surface to form a passage between the holding member and the concave surface, the passage configured and arranged to frictionally hold food stuff therein.

2. The pet toy of claim 1, wherein the concave surface includes teething nubs.

3. The pet toy of claim 1, wherein the resilient base member includes a hollow interior portion.

4. The pet toy of claim 1, wherein the concave surface includes an opening which provides access to the hollow interior portion.

5. The pet toy of claim 1, wherein the holding member is a rope lace.

6. The pet toy of claim 1, wherein the holding member is a first holding member and the pet toy further includes a second holding member positioned adjacent the first holding member.

7. The pet toy of claim 1, wherein the concave surface is a first concave surface and the pet toy further includes a second concave surface.

8. The pet toy of claim 7, wherein the second concave surface has a radius of curvature that is less than a radius of curvature of the first concave surface.

9. The pet toy of claim 7, wherein the holding member is a first holding member and the pet toy further includes a second holding member passing through the second concave surface.

10. The pet toy of claim 9, wherein the passage is a first passage and the second holding member and the second concave surface for a second passage, the second passage having a smaller cross sectional area than the first passage.

11. The pet toy of claim 7, wherein the first concave surface includes a first opening which provides access to a hollow interior portion of the resilient member and the second concave surface has a second opening which provides access to a hollow interior portion of the resilient member, the second opening having a diameter that is less than the diameter of the first opening.

12. The pet toy of claim 7, wherein the second concave surface includes teething nubs.

13. The pet toy of claim 1, wherein the first portion of the holding member is configured to be adjusted when a force is applied to the second portion of the holding member.

14. The pet toy of claim 1, wherein the holding member is adjustable.
